(19) United States
(12) Patent Application Publication
(10) Pub. No.: US 2009/0184107 A1
(43) Pub. Date: Jul. 23, 2009

(54) HEATING ELEMENT WITH STRANDED CONTACT

(76) Inventor: Michael Weiss, Benediktbeuren (DE)

Correspondence Address: DICKINSON WRIGHT PLLC, 38525 WOODWARD AVENUE, SUITE 2000, BLOOMFIELD HILLS, MI, 48304-2970, US

(21) Appl. No.: 12/338,971

(22) Filed: Dec. 18, 2008

Related U.S. Application Data
(63) Continuation-in-part of application No. 10/415,798, filed on Sep. 12, 2003, now abandoned.

(30) Foreign Application Priority Data
Sep. 3, 2001 (DE) 101 42 878.2

(51) Int. Cl. H05B 3/08

(52) U.S. Cl. 219/541

(57) ABSTRACT

The invention relates to a heating element (1) with a flat heater resistor (2) and at least two contact regions (4, 4′) that are arranged a distance apart from one another on the heater resistor (2). Provision is made for at least one of the contact regions (4, 4′) to have a stranded wire assembly (6, 6′), which stands in electrically conductive connection with the heater resistor (2) over a relatively great distance (8). The stranded wire assembly (6,6′) is comprised of a plurality of filament wires (9,9′) which are twisted together only loosely such that the stranded wire assembly (6,6′) may be compressed into a substantially flat cross-section.

### CROSS REFERENCE TO RELATED APPLICATIONS

This application is a continuation-in-part of U.S. patent application Ser. No. 10/415,798, filed on Sep. 12, 2003.

### TECHNICAL FIELD

The present invention relates to a heating element with a heater resistor and at least two contact regions arranged a distance apart from one another on the heater resistor. Generic heating elements are used to heat surfaces of useful items standing in contact with a user.

### BACKGROUND OF THE INVENTION

It is known to contact electrically conductive textiles with sewn-on electrodes. However, this process is very cost-intensive under certain circumstances.

It is also known to use metallic or metallized adhesive tapes as electrodes for flat heater resistors. However, problems arise regarding the durability of the adhesive connection and in ensuring adequate passage of current from the electrode to the flat heater resistor.

Riveted connections are also known. However, these represent a source of mechanical problems. Moreover, riveted connections only provide a point electrical contact.

### SUMMARY OF THE INVENTION

The present invention provides a heating element with a flat heater resistor and at least two contact regions that are arranged a distance apart from one another on the heater resistor. At least one of the contact regions has a stranded wire assembly which stands in electrically conductive connection with the heater resistor over a relatively apart distance. The stranded wire assembly is comprised of a plurality of filament wires loosely twisted together. It should be understood that loosely twisting the filament wires together can also be referred to as the stranded wire assembly being twisted. A heating element in accordance with the present invention permits the introduction of current from an electrode to a flat heater resistor over a large area. In addition, it is easy to automate production of such a connection, and thus it is economical. Moreover, such an electrode is also capable of withstanding continuous mechanical stress.

A heating element in accordance with the present invention wherein the distance over which the stranded wire assembly is in contact with the heater resistor is greater than 2 cm, such as 10 cm, is also disclosed. Such a heating element is characterized by a good conductive connection between an electrode and a flat heater resistor.

A heating element wherein the stranded wire assembly stands in electrically conductive connection with the heater resistor over essentially all of a direction of extension of the heater resistor is also disclosed. Such a heating element permits distribution of the supplied current over the entire available width or length of the heating element.

A heating element wherein the number of filament wires is at least 40, such as 60-120 or 80-110, is also disclosed. Such a heating element has a great number of current-carrying filament wires and hence a large contact surface between electrode and flat heater resistor.

A heating element wherein the diameter of the filament wire is between 10 and 100 μm, such as between 40 and 60 μm, is also disclosed. Such a heating element has a relatively large diameter of the filament wires in comparison to conventional stranded wires. As a result, the resistance of the individual wires is reduced.

A heating element wherein two stranded wire assemblies are provided instead of a single stranded wire is also disclosed. Such a heating element permits an increase in the amount of current that can be supplied without excessively increasing the material costs.

A heating element wherein the stranded wire assembly has a maximum of 10 turns per meter for twisting of the filament wires about its longitudinal axis, such as 5 turns per meter or 1 turn per meter, is also disclosed. This means that the filament wires within the stranded wire assembly are twisted together with a maximum 10 turns per meter. Such a heating element permits conformation of the stranded wire to the heating element over a large area, due to twisting of the loosely wound filament wires. The transition resistance is significantly reduced in this way.

A heating element wherein the filament wires and/or the stranded wire assemblies have a silver coating, is also disclosed. Such a heating element likewise produces a reduction in transition resistance.

### BRIEF DESCRIPTION OF THE DRAWINGS

The description to follow deals with possible conformations of the invention. These embodiments are to be understood as examples only, and are explained with reference to:

FIG. 1 which shows a top view of a section of a heating element in accordance with one embodiment of the invention; and

FIG. 2 which shows a cut away perspective view of a stranded wire assembly for supplying current to the heating element of FIG. 1.

### DESCRIPTION OF THE INVENTION

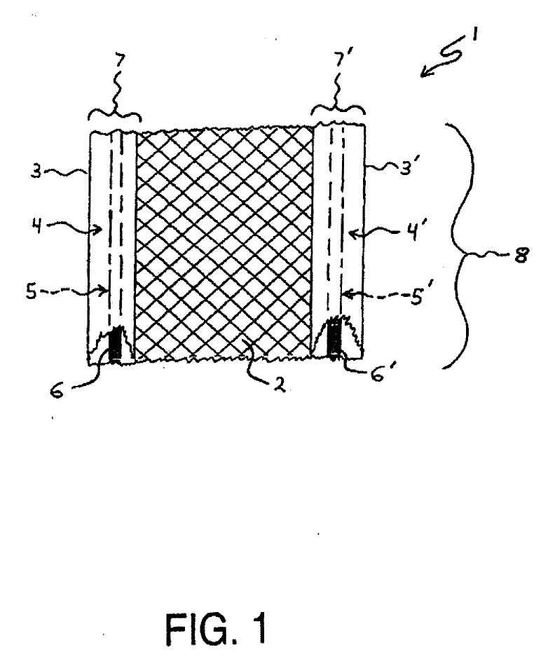

FIG. 1 shows a top view of a section of a heating element 1 in accordance with an embodiment of the invention. The heating element 1 has a flat, band-like heater resistor 2. Provided on the longitudinal sides (7,7′) of the heater resistor 2 are contact regions (4, 4′). In each case, the contact regions (4, 4′) are formed by folding over the longitudinal edges (7,7′) of the heater resistor 2. In this way, each contact region (4, 4′) takes the shape of a tubular pocket (5,5′).

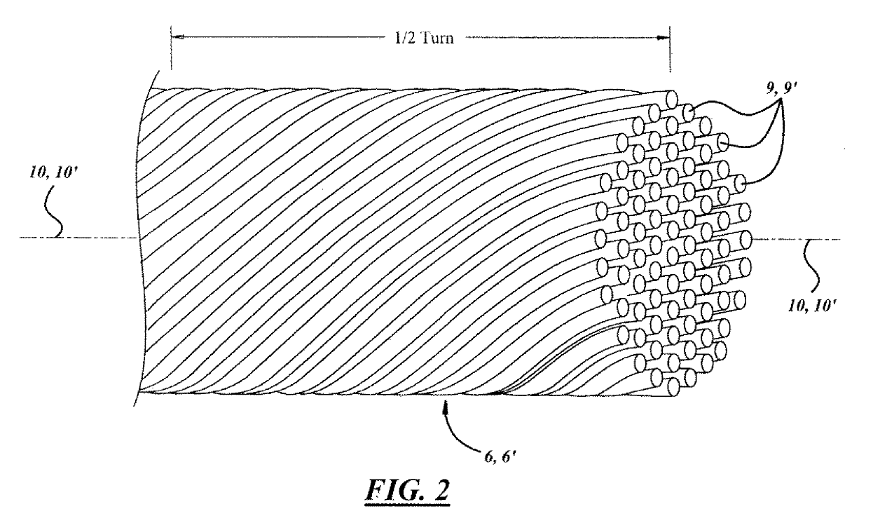

One stranded wire assembly (6, 6′) is provided in each of the tubular pockets (5,5′) of the contact regions (4, 4′). As shown in FIG. 2, the stranded wire assembly (6, 6′) has a relatively large number of filament wires (9,9′), preferably between 40 and 110 filament wires (9,9′) per stranded wire assembly (6,6′). In the present example embodiment, there are approximately 80 filament wires (9,9′) per stranded wire assembly (6,6′).

The filament wires (9,9′) preferably have a diameter from 10-100 μm, and in the present example embodiment, 50 μm.

As shown in FIG. 2, the stranded wire assembly (6,6′) is comprised of filament wires (9,9′) twisted together only loosely. This is the same as saying that the stranded wire assembly (6,6′) is twisted only loosely. It should be understood that when it is said that the stranded wire assembly (6,6′) is twisted, this means that the filament wires (9,9′) that make it up are twisted together. The number of turns is preferably from 0 to 10, and in the present example embodiment there is one turn of the stranded wire assembly (filament wires (9,9′) per meter. The filament wires (9,9′) are only loosely twisted together such that there are gaps in between individual filament wires (9,9′), see FIG. 2. The loose twisting that results in the presence of gaps between individual filaments allows the strand wire assembly (6,6′) to be flattened such that its cross-section is no longer cylindrical but is in fact substantially flat. The individual filament wires (9,9′) can shift due to the gaps and flatten the strand wire assembly (6,6′) allowing its placement in a variety of narrow applications wherein conventional twisted strand wire assemblies would not work due to their rigid cross-section. The term “conventional twisted wires” is a term used to refer to typical industry twisted wires which impart twists into the wire at a rate greater that 20 turns per meter. Often these wires have at least one twist per inch. This makes the individual fibers hold together properly for conventional applications but prevents the cross-section from flattening in situations wherein a substantially flat cross-section is desirable.

The filament wires (9,9′) are provided with a silver coating to increase their conductivity. This allows easier current transmission from the stranded wire assembly (6, 6′) to the heater resistor 2.

The stranded wire assembly (6, 6′) runs lengthwise along the entire length of the heater resistor 2. This permits current to be supplied to the heater resistor 2 over the entire length of the heating element 1. In this way, very wide or long heating elements can be realized.

The stranded wire assembly (6, 6′) can simply be inserted in the tubular pocket in the contact region (4, 4′). However, it can also be additionally attached, for example through sewing, gluing or riveting.

The tubular pocket in the contact region can also be formed by additionally applied strips of material, for example adhesive or hook-and-loop strips, instead of by the material of the resistance element 2. It would also be possible to omit a tubular embodiment of the contact regions. The stranded wire assembly (6,6′) could also be applied to the resistance element uncovered on one side.

Instead of a single stranded wire assembly (6,6′), two stranded wire assemblies could also be laid next to each other in each contact region. The amount of current that can be supplied could be increased easily in this way. While a larger number of stranded wire assemblies is also conceivable, it is less desirable because of additional material costs.

1. A heating element (1) comprising:
a flat heater resistor (2);
at least two contact regions (4, 4′) that are arranged a distance apart from one another on the heater resistor (2), wherein at least one of the contact regions (4, 4′) includes an elongate pocket (5, 5); and
a stranded wire assembly (6, 6′) inserted within each elongate pocket (5, 5′) so as to be in electrically conductive connection with the heater resistor (2) over a distance (8), the stranded wire assembly (6, 6′) comprising a plurality of filament wires (9, 9′), the filament wires (9, 9′) are, at most, only loosely twisted together.

2. A heating element (1) according to claim 1 wherein the distance (8) over which the stranded wire assembly (6, 6′) is in contact with the heater resistor (2) is greater than 2 cm.

3. A heating element (1) according to claim 1 wherein the distance (8) over which the stranded wire assembly (6, 6′) is in contact with the heater resistor (2) is greater than 10 cm.

4. A heating element (1) according to claim 1 wherein the stranded wire assembly (6, 6′) is in electrically conductive connection with the heater resistor (2) over substantially an entire direction of extension of the heater resistor (2).

5. A heating element (1) according to claim 1 wherein the distance (8) over which the stranded wire assembly (6, 6′) is in contact with the heater resistor (2) is greater than 2 cm, and wherein the stranded wire assembly (6, 6′) is in electrically conductive connection with the heater resistor (2) over substantially an entire direction of extension of the heater resistor (2).

6. A heating element (1) according to claim 1 wherein the number of filament wires (9, 9′) is at least 40.

7. A heating element (1) according to claim 1 wherein the number of filament wires (9, 9′) is between 60 and 120.

8. A heating element (1) according to claim 1 wherein the number of filament wires (9, 9′) is between 80 and 110.

9. A heating element (1) according to claim 1 wherein the distance (8) over which the stranded wire assembly (6, 6′) is in contact with the heater resistor (2) is greater than 2 cm, and wherein the number of filament wires (9, 9′) is at least 40.

10. A heating element (1) according to claim 1 wherein the stranded wire assembly (6, 6′) is in electrically conductive connection with the heater resistor (2) over substantially an entire direction of extension of the heater resistor (2), and wherein the number of filament wires (9, 9′) is at least 40.

11. A heating element (1) according to claim 1 wherein the elongate pocket (5, 5′) is formed by a rolled longitudinal edge (7, 7′) of the heater resistor (2) so as to render the elongate pocket (5, 5′) substantially tubular.

12. A heating element (1) according to claim 11 wherein the stranded wire assembly (6, 6′) is closely received within the elongate pocket (5, 5′).

13. A heating element (1) according to claim 1 wherein each of the filament wires (9, 9′) has a diameter of between approximately 10 to 100 μm.

14. A heating element (1) according to claim 1 wherein the plurality of filament wires (9, 9′) are twisted together at a rate of between 0 and 10 turns per meter about the longitudinal axis (10, 10′) of the stranded wire assembly (6, 6′).

15. A heating element (1) according to claim 1 wherein at least one of the plurality of filament wires (9, 9′) includes a silver coating for increasing its electrical conductivity.

16. A heating element (1) according to claim 1 wherein at least one elongate pocket (5, 5′) includes an additional stranded wire assembly inserted therein.

17. A heating element (1) according to claim 1 wherein the plurality of filament wires (9,9′) are loosely twisted together such that there are gaps between individual filament wires (9,9′).

18. A heating element (1) according to claim 1, wherein the plurality of filament wires (9,9′) are loosely twisted together such that the stranded wire assembly (6,6′) may be compressed to have a substantially fiat cross-section.

19. A heating element (1) comprising:
a flat heater resistor (2);
two contact regions (4, 4′) each arranged along a different edge (3, 3′) of the heater resistor (2) and spaced apart from each other, at least one of the contact regions (4, 4′) comprising a tubular pocket (5, 5′) formed by a rolled longitudinal edge (7, 7′) of the heater resistor (2); and
a stranded wire assembly (6, 6′) in each tubular pocket (5, 5′), each stranded wire assembly (6, 6′) being in electrically conductive connection with at least a portion of the heater resistor (2) and comprising a plurality of filament wires (9, 9′), said filament wires (9, 9′), at most, only loosely twisted together.

20. A heating element (1) according to claim 19 wherein each stranded wire assembly (6, 6′) comprises at least 40 filament wires (9, 9′) twisted at a rate of between 0 and 10 turns per meter about the longitudinal axis (10, 10′) of the stranded wire assembly (6, 6′).

21. A heating element (1) according to claim 20 wherein each stranded wire assembly (6, 6′) is in electrically conductive connection with the heater resistor (2) over substantially an entire direction of extension of the heater resistor (2).

22. A heating element (1) according to claim 19, wherein each stranded wire assembly (6,6′) may be compressed into a substantially flat cross-section due to said filament wires (9,9′) being only loosely twisted together.

23. A heating element (1) according to claim 19, wherein the plurality of filament wires (9,9′) are loosely twisted such that gaps are present between individual filament wires (9,9′).
